(19) United States
(12) Patent Application Publication
(10) Pub. No.: US 2024/0242141 A1
(43) Pub. Date: Jul. 18, 2024

(54) METHOD OF OPTIMIZING EQUIPMENT MAINTENANCE AND ASSOCIATED SYSTEM

(71) Applicant: INFICON, Inc., East Syracuse, NY (US)

(72) Inventors: Jeff Chihfeng Chien, Austin, TX (US); David Aaron Wizelman, Austin, TX (US)

(73) Assignee: INFICON, Inc., East Syracuse, NY (US)

(21) Appl. No.: 18/290,233

(22) PCT Filed: May 12, 2022
(86) PCT No.: PCT/US2022/028936

§ 371 Date: Nov. 10, 2023

Related U.S. Application Data
(60) Provisional application No. 63/188,059, filed on May 13, 2021.

(51) Int. Cl. G06Q 10/0631; G06Q 10/04

(52) U.S. Cl. CPC G06Q 10/063112; G06Q 10/04

(57) ABSTRACT

A method of maintenance optimization for production equipment in a factory includes specifying a time period and determining maintenance tasks to be performed on each piece of production equipment over the specified time period. The technician skills required to perform each maintenance task are determined. The availability of each technician during the specified time period and their certifications are then determined. The parts required for each maintenance task and a parts inventory are determined. A production schedule for the specified time period is then determined. A recommended maintenance schedule is generated which minimizes production impact during the specified time period based on the determined maintenance tasks, technician availability and certifications and parts availability. The recommended maintenance schedule includes a recommended time to perform each maintenance task and a recommended technician to perform each maintenance task.

### CROSS REFERENCE TO RELATED APPLICATION

This application is a national stage application pursuant to 35 U.S.C. 371 of International Patent Application No. PCT/US2022/028936, filed May 12, 2022, which claims the benefit of and priority to U.S. Provisional Patent Application Ser. No. 63/188,059, filed May 13, 2021, and entitled “MAINTENANCE OPTIMIZER,” the entirety of which is incorporated herein by reference.

### TECHNICAL FIELD

The foregoing disclosure relates to a method of optimizing equipment maintenance. Specifically, the method uses several types of information, such as personnel information, information pertaining to the availability of needed part, and information pertaining to an equipment operating schedule, in order to determine a maintenance schedule for equipment that minimizes the impact on the operation schedule during the time period that the subject equipment is being maintained. This disclosure also relates to a system for optimizing production equipment maintenance.

### BACKGROUND OF THE INVENTION

Semiconductors are an important component used in the production of many different types of consumer and industrial products. For example, semiconductors are used to fabricate integrated circuits (microchips) and photovoltaics. The integrated circuits are then incorporated into thousands of other products ranging from portable electronic devices, such as a mobile phone, to a satellite orbiting the planet. The photovoltaics are used to manufacture solar cells used to convert sunlight into electrical power. In order to keep up with the global demand for these products, semiconductor manufacturers operate enormous factories with hundreds of pieces of manufacturing equipment that run all day and every day to produce semiconductor wafers. The overall success of the semiconductor manufacturing company depends upon the output of finished wafers, which in turn depends upon the ability of a piece of semiconductor manufacturing equipment to operate in an efficient manner as long as possible. In order for semiconductor manufacturing equipment to operate efficiently, it must be properly maintained in a preventative manner according to a schedule. Deviation from such preventative maintenance is certain to lead to equipment failure, which can cost the manufacturer large sums of money related to equipment repair or replacement, as well as lost revenue due to the extended time such equipment spends offline. Unfortunately, such preventative maintenance also acts to slow semiconductor production as the equipment under maintenance must be taken offline until the maintenance is completed.

The maintenance scheduling methods and systems currently used are highly manual, which increases error. Moreover, these methods do not accurately comprehend the impact on operations, and specifically on the operations of a semiconductor manufacturing factory.

These are some of the disadvantages manufacturers face regarding scheduling and performing equipment maintenance.

### SUMMARY OF THE INVENTION

The following disclosure is related to a method of scheduling maintenance on manufacturing equipment in a manner that minimizes the overall impact on operations. The method considers several factors including the technicians available to perform such maintenance and their respective certifications, operations schedules, the availability of parts and/or tools required for the scheduled maintenance.

An embodiment of the method of scheduling maintenance tasks for production equipment includes specifying a time period for performance of the maintenance tasks. The maintenance tasks to be performed during the specified time period on each piece of production equipment are determined. The technician skills required to perform each maintenance task are determined as well as the availability of each technician during the specified time period and any certifications acquired by each technician. The parts required to perform the maintenance are determined and cross-checked with the parts in inventory. The production schedule is determined during the specified time period. The production schedule is a function of the current and predicted work-in-progress, which is the result of customer orders. A recommended maintenance schedule is then generated taking into account all of the determined information in order to minimize production impact during the specified time period while completing as many maintenance tasks as possible.

In an embodiment, the method includes displaying the recommended maintenance schedule in a calendar format on a graphical user interface. In another embodiment, the method includes determining which tools are required to perform each maintenance task. In an embodiment, the method includes accepting the recommended maintenance schedule. In an embodiment, the method includes sending the accepted maintenance schedule to the available technicians. In another embodiment, the method further includes adjusting the recommended maintenance schedule based on real time changes in one or more pieces of determined information originally used to generate the recommended maintenance schedule.

An embodiment of a system for optimizing equipment maintenance includes a scheduler including a user input interface and a user output interface. The scheduler is configured to receive input information from a user at the user interface. In addition to the information from the user, the scheduler is configured to receive information from one or more external information sources. In an embodiment, the one or more external information sources include a parts inventory database, a human resources database and a production schedule.

### BRIEF DESCRIPTION OF THE DRAWINGS

A more particular description of the invention briefly summarized above may be had by reference to the embodiments, some of which are illustrated in the accompanying drawings. It is to be noted, however, that the appended drawings illustrate only typical embodiments of this invention and are therefore not to be considered limiting of its scope, for the invention may admit to other equally effective embodiments. Thus, for further understanding of the nature and objects of the invention, references can be made to the following detailed description, read in connection with the drawings in which:

FIG. 1A illustrates an embodiment of a method of optimizing equipment maintenance;

FIG. 1B is a continuation of FIG. 1A;

FIG. 2 illustrates another embodiment of the method of optimizing equipment maintenance;

FIG. 3 schematically illustrates an embodiment of a scheduler in electrical communication with a plurality of external information sources on a network;

FIG. 4 illustrates an embodiment of a maintenance calendar generated by the scheduler on a GUI;

FIG. 5 illustrates an embodiment of a maintenance calendar generated by the scheduler on a GUI;

FIG. 6 illustrates an embodiment of an optimized version of the calendar of FIG. 5;

FIG. 7 illustrates an embodiment of the calendar of FIG. 6 for an individual piece of production equipment;

FIG. 8 illustrates an embodiment of the calendar of FIG. 6 for an individual technician; and

FIG. 9 illustrates an embodiment of the calendar of FIG. 6 showing all maintenance tasks, assigned technicians and the required tools for each task.

The attached drawings are for purposes of illustration and are not necessarily to scale.

### DETAILED DESCRIPTION OF THE INVENTION

The following discussion relates to various embodiments of a method of optimizing equipment maintenance. It will be understood that the herein described version(s) are examples that embody certain inventive concepts as detailed herein. To that end, other variations and modifications will be readily apparent to those of sufficient skill.

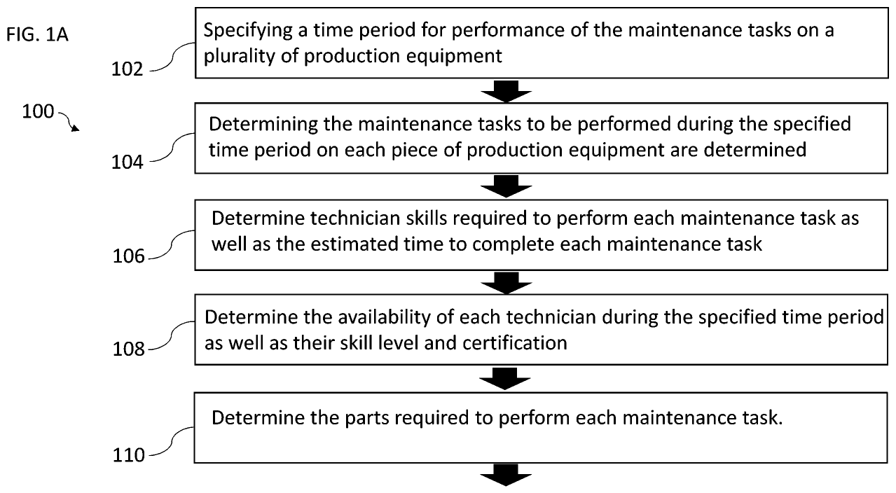

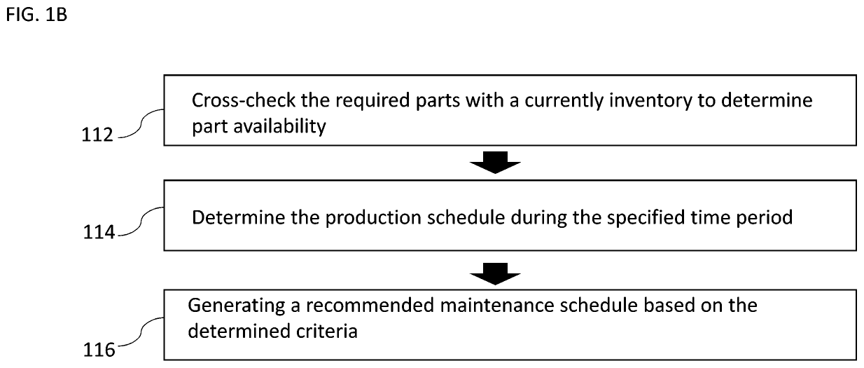

An embodiment of the method 100 will now be described with reference to the flow-chart shown in FIGS. 1A-B. First, the time period for performing the maintenance tasks is determined 102. Maintenance tasks to be performed on each piece of production equipment during the time period are determined 104. These tasks are then matched with technicians who are available during the time period 106. The matching takes into account a technician's skill and certifications 108. Then, the required parts for each maintenance task are determined 110 and cross-referenced with a current inventory of parts 112. Finally, the production schedule is determined for the time period 114. The production schedule is a function of the current and predicted work-in-progress, which is the result of customer orders. A proposed maintenance schedule, which matches a technician to each maintenance task and allocates any required parts is then generated 116. The proposed maintenance schedule optimizes the available labor while minimizing the impact of said maintenance on overall production. The recommended maintenance schedule may be output to a graphical user interface that can be printed and or electronically shared with others.

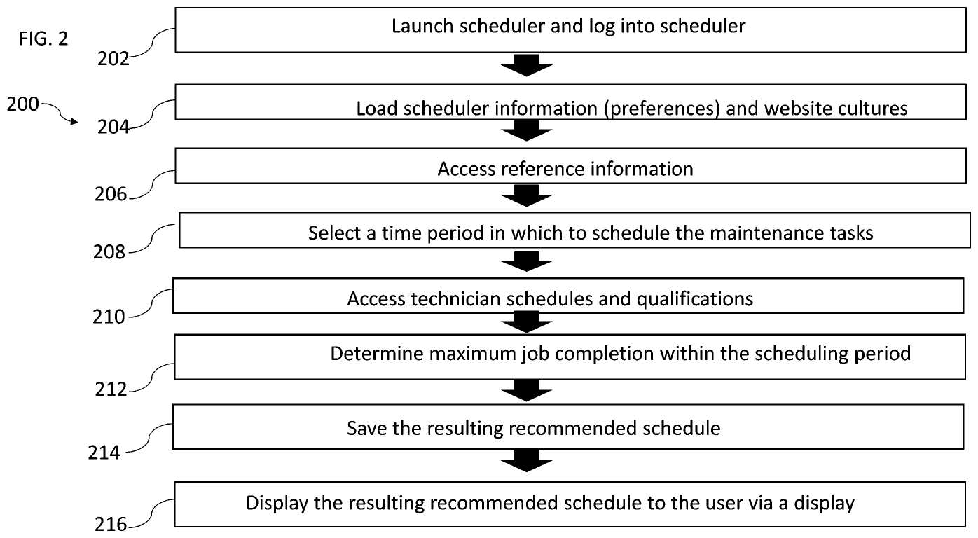

Another embodiment of the method 200 is described with reference to FIG. 2. In another embodiment, the method begins by the user launching and logging into the scheduler via a user interface such as a keypad or keyboard, or through a biometric login 202. Once the user is logged in, preference information and/or information pertaining to current and/or previous maintenance schedules is presented to the user 204. Reference information is then accessed 206. The reference information can include preventative maintenance schedules for each piece of production equipment, which are entered manually or automatically uploaded. For example, a preventative maintenance schedule for a particular piece of production equipment may include recalibration every three (3) months, sensor replacement every six (6) months and a complete cleaning every (4) months.

Once logged in, the user can select a time period 208, for example a one (1) month time period or a specific month, such as May. In addition to the preventative maintenance tasks, additional maintenance tasks can be requested by the user. The scheduler then determines personnel information for technician availability during the specified time period, their skill levels, and/or any certifications they may have acquired 210. The scheduler then determines a maximum task completion schedule during the selected time period 212. This schedule is then saved 214 in a memory component and the schedule is then output to a display 216.

In an embodiment, prior to generating a recommended schedule, the scheduler further determines the availability of the equipment parts required for each maintenance task as well as an estimated time to complete each maintenance task. The scheduler then determines the production schedule for the production equipment during the selected time period. The scheduler then then determines the maximum job completion within the scheduling period with the least impact on the overall production schedule. In other words, the scheduler generates a maintenance task schedule for the selected time period that considers the skills of the available technicians, the availability of the require parts, the estimated time required to perform each maintenance task and the production schedule, such that the generated maintenance schedule allows for the most maintenance tasks to be performed during the selected time period while also having the lowest impact on the production schedule.

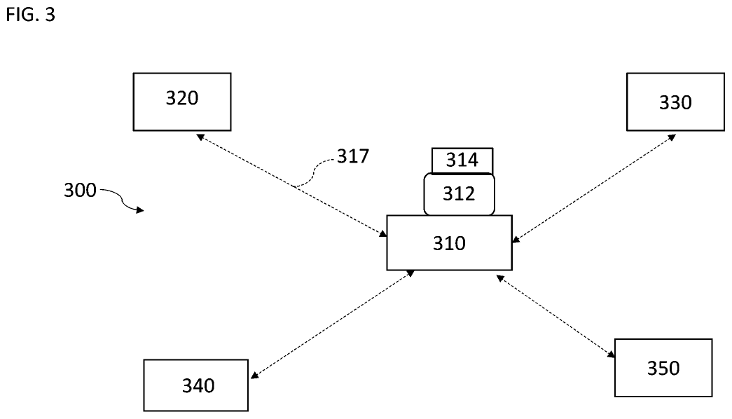

Referring to FIG. 3, another embodiment of the method is performed by a scheduler 300 that has a GUI and is in communication with one or more other devices on a communications network. The one or more other devices on the network are structured to hold human resource information 320 pertaining to the qualifications of each maintenance technician as well as vacation and sick/personal day schedules for each of the maintenance technicians. The scheduler 300 may further be in communication with a warehouse controller 330 that tracks the inventory of new or spare parts for the production equipment. The scheduler 300 may also be in communication with a sales database and/or a production schedule database 340. In addition, the scheduler 300 may be in communication with a tool scheduler 350 as is described further below. Accordingly, the scheduler 300 is configured to obtain information from these multiple outside sources 320, 330, 340, 350 and consider such information when generating a proposed maintenance schedule. In this manner, the scheduler 300 is able to generate an optimal maintenance schedule where available human resources and inventory are utilized in the most efficient manner to perform as many maintenance tasks as possible during the desired time period, while still optimizing overall output.

The scheduler 300 may further be in electrical communication to a user input device 305 and a GUI 310. In this manner, the user may input information in response to scheduler prompts displayed by the GUI 310. For example, the user may be prompted to indicate the desired time period that the proposed maintenance schedule should cover. Accordingly, the user may be further prompted to narrow the desired time period by indicating days/times that are not to be included in the schedule. For example, the user can indicate that no maintenance will be performed on Tuesdays, and/or on federal holidays, and/or after 6 pm and/or before 6 am.

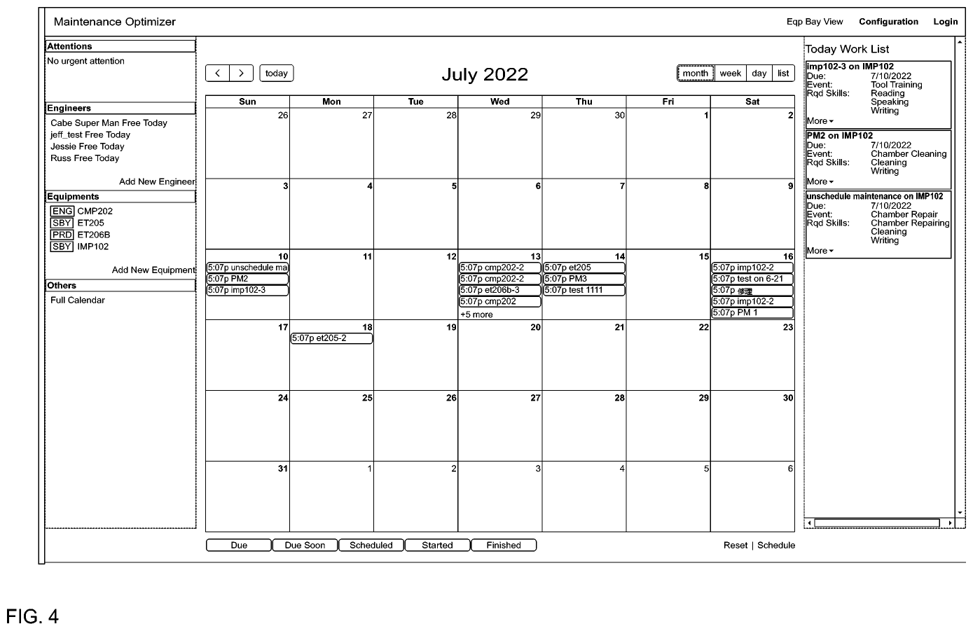

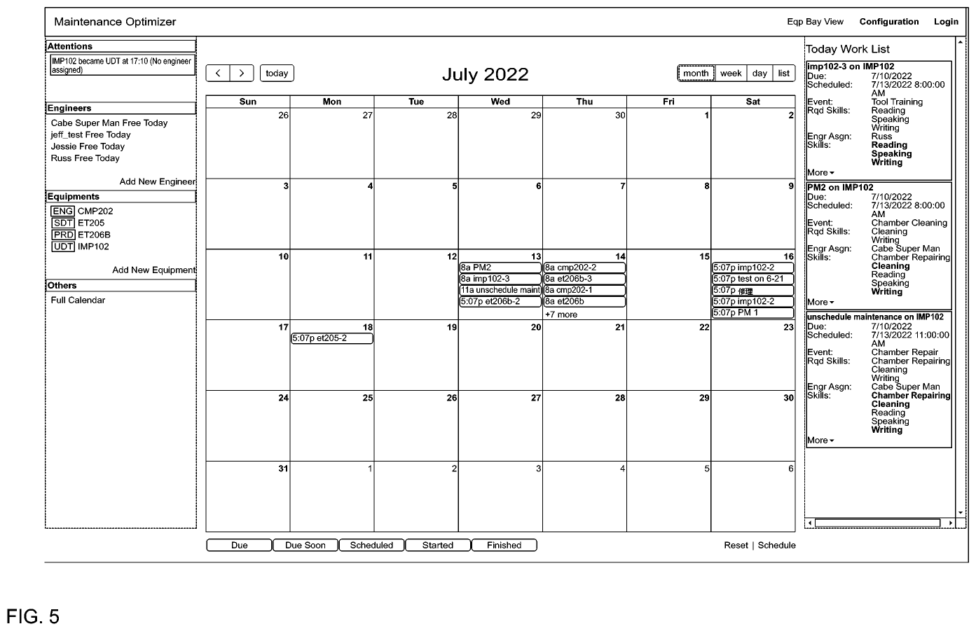

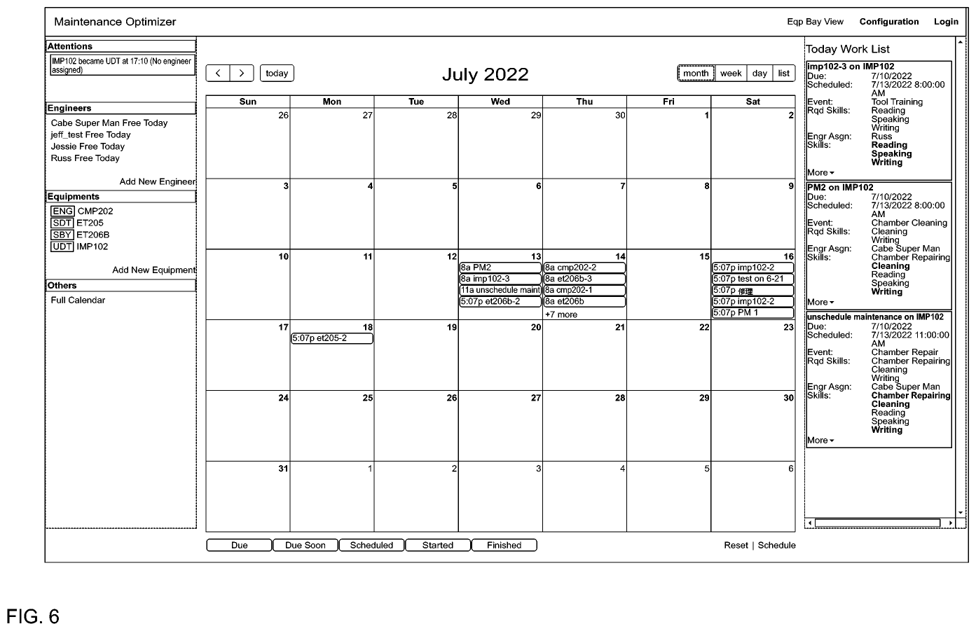

As shown in FIG. 4, the proposed maintenance schedule can be displayed in calendar form indicating which day and time period during the day that the maintenance will be performed as well as who will be performing the maintenance and what parts are required. Referring to FIG. 5, the scheduler 300 (see FIG. 3) is able to display all the maintenance tasks 410 that are due to be performed. The right side of the calendar lists the required technician skills 412 for each of the maintenance tasks. The calendar of FIG. 6 is the result of running the optimization method. As can be seen, no maintenance tasks are scheduled for the weekend and a decrease in maintenance tasks are seen on Monday and Wednesday versus the calendar of FIG. 5. This is the result of blending the list of maintenance tasks that are due with the skill level of the available technicians.

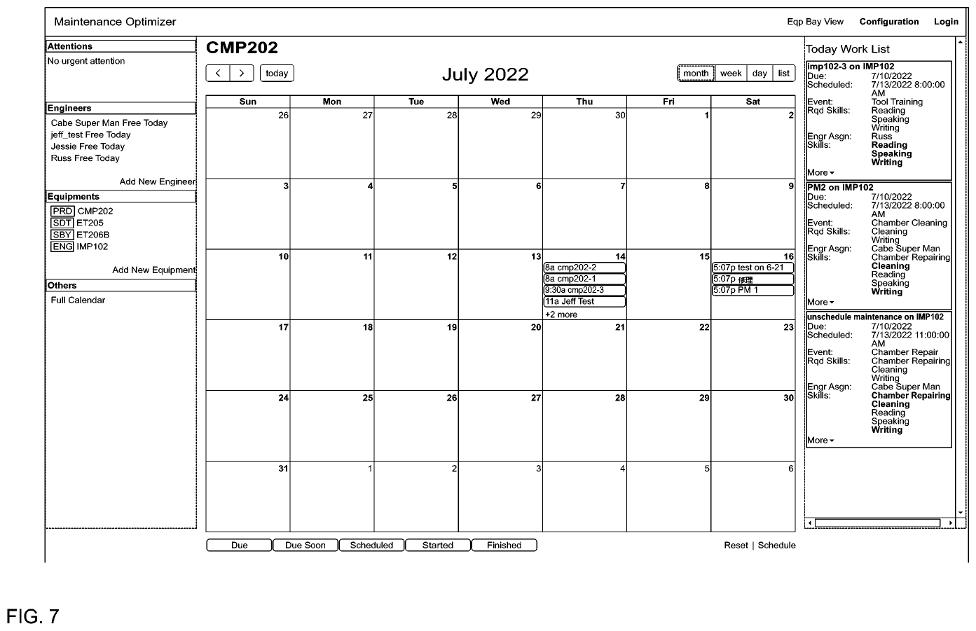

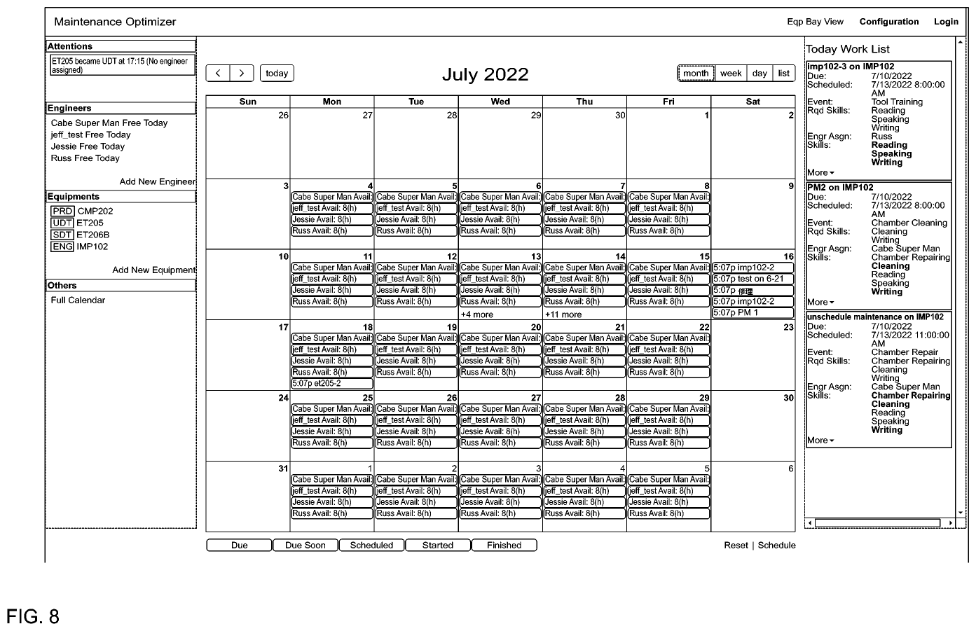

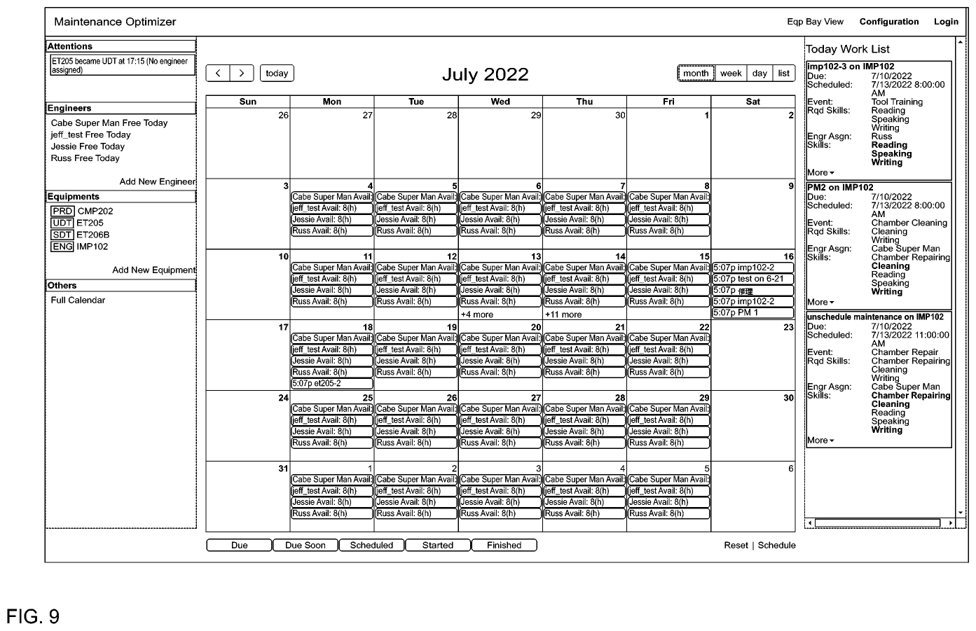

The calendar views can be manipulated depending on the information that the user desires to view. For example, the calendar for a specific piece of production equipment (CMP202) can be generated as is shown in FIG. 7. Alternatively, a schedule of maintenance tasks being performed by a specific technician can be generated as is shown in FIG. 8. Finally as shown in FIG. 9, it is possible output a calendar showing all of the maintenance tasks including the technician assigned to each task and the tools that will be required to perform each maintenance task.

In an embodiment, additional information can be incorporated into the scheduling method from a tool scheduler 350 (see FIG. 3) used to schedule usage of various tools. For example, if tool A is required for maintenance task A and B and there are only two (2) of tool A with a maintenance schedule that includes three (3) of maintenance task A and two (2) of maintenance task B, then the method 100, 200 9 or scheduler 3000 accounts for this extra variable in generating the proposed maintenance schedule.

It is possible for the method 100, 200 to yield more than one proposed maintenance schedule for the desired time period that have the same level of optimization. In an embodiment, the user may have a choice whether to accept or decline the proposed maintenance schedule. If the proposed maintenance schedule is declined, then the user may be given the option to input additional information or criteria. In another embodiment, the act of declining a proposed maintenance schedule prompts the method 100, 200 to be performed again to generate a different proposed maintenance schedule, which may be as optimal or less optimal as the previously proposed schedule.

If the generated maintenance schedule is accepted, then some or all of said schedule can be electronically shared with other individuals including being automatically sent to technicians, equipment operators, warehouse personnel and/or anyone identified by the user. In an embodiment, the disclosed methods 100, 200 enable the use of real time information provided by the external information sources. For example, if a technician unexpectedly calls in sick or is fired, or a rushed product order has been accepted, then the change(s) in external information are automatically incorporated into the accepted schedule and the schedule is changed to account for said information. In a further embodiment, the user can manually add additional information/resources to an accepted schedule. For example, the user may add one or more additional parts to a maintenance task and/or may add an additional technician to a maintenance task, such as for training purposes. The additional resources are then taken into account in the generation of further proposed maintenance schedules.

The invention is inclusive of combinations of the aspects described herein. References to an “embodiment” and the like refer to features that are present in at least one aspect of the invention. Separate references to “an embodiment” or “particular aspects” or the like do not necessarily refer to the same aspect or aspects; however, such aspects are not mutually exclusive, unless so indicated or as are readily apparent to one of skill in the art. The word “or” is used in this disclosure in a non-exclusive sense, unless otherwise explicitly noted.

The invention has been described in detail with particular reference to certain preferred aspects thereof, but it will be understood that variations, combinations, and modifications can be effected by a person of ordinary skill in the art within the spirit and scope of the invention.

1. A method of maintenance optimization for production equipment in a factory, comprising:
specifying a time period;
determining maintenance tasks to be performed on each piece of production equipment over the specified time period;
determining technician skills required to perform each maintenance task;
determining availability of each technician during the specified time period and certifications for each available technician;
determining parts required for each maintenance task and a parts inventory;
determining a production schedule for the specified time period;
generating a recommended maintenance schedule which minimizes production impact during the specified time period based on the determined maintenance tasks, technician availability and certifications and parts availability, wherein the recommended maintenance schedule includes a recommended time to perform each maintenance task and a recommended technician to perform each maintenance task.

2. The method of claim 1, further comprising displaying the recommended maintenance schedule in a calendar format on a graphical user interface.

3. The method of claim 1, further comprising determining which tools are required to perform each maintenance task.

4. The method of claim 1, further comprising accepting the recommended maintenance schedule.

5. The method of claim 4, further comprising sending the accepted maintenance schedule to the available technicians.

6. The method of claim 1, further comprising adjusting the recommended maintenance schedule based on real time changes in one or more pieces of determined information originally used to generate the recommended maintenance schedule.

7. A maintenance scheduling system comprising:
a scheduler device including a user input interface and an output interface; and
a plurality of external information sources in electrical communication with the scheduler device, wherein the scheduler device is configured to:
enable a time period to be specified,
determine maintenance tasks to be performed on each piece of production equipment over the specified time period,
obtain information on one or more technicians from one of the plurality of external information sources,
obtain information on the parts required for each maintenance task and a parts inventory from one of the plurality of external information sources,
obtain a production schedule for the specified time period from one of the plurality of external information sources, and
generate a recommended maintenance schedule which minimizes production impact during the specified time period based on the obtained information, wherein the recommended maintenance schedule includes a recommended time to perform each maintenance task and a recommended technician to perform each maintenance task.

8. The system of claim 7, wherein the recommended maintenance schedule is displayed in a calendar format on the graphical user interface.

9. The system of claim 7, wherein the scheduler device is further comprised to obtain information from another of the plurality of external information sources pertaining to which tools are required to perform each maintenance task.

10. The system of claim 7, wherein the scheduler device is configured to send the recommended maintenance schedule to the available technicians.

11. The method of claim 7, wherein the scheduler device is further configured to adjust the recommended maintenance schedule based on real time changes in one or more of the obtained information originally used to generate the recommended maintenance schedule.
